(19) United States
(12) Patent Application Publication
(10) Pub. No.: US 2008/0189736 A1
(43) Pub. Date: Aug. 7, 2008

(54) System and method for displaying information related to a television signal

(75) Inventors: Greg Edwards, Austin, TX (US); Javier Arellano, Austin, TX (US); Donald Garofalo, Austin, TX (US); Paul Van Vleck, Austin, TX (US); Marc Sullivan, Austin, TX (US)

Correspondence Address: G. Michael Roebuck, PC, FROST BANK BUILDING, 6750 WEST LOOP SOUTH, SUITE 920, BELLAIRE, TX, 77401, US

(73) Assignee: SBC Knowledge Ventures L.P., Reno, NV (US)

(21) Appl. No.: 11/704,163

(22) Filed: Feb. 7, 2007

(51) Int. Cl. H04N 7/025

(52) U.S. Cl. 725/34

(57) ABSTRACT

A computerized method and system are disclosed for presenting information in an internet protocol television (IPTV) system. The method includes sensing at an end user device, reference data inserted into a video data stream from the IPTV system, weighting at the end user device, the reference data sensed in the video data stream based on a data type for the sensed reference data and presenting at the end user device the information selected based on the weighted reference data concurrently with the video data stream. A system for performing the method and a computer readable medium containing a computer program for performing the method are disclosed. A data structure embedded in a computer readable medium for providing a structural and functional interrelationship between data stored in the data structure and computer hardware and software is disclosed.

### FIELD OF THE DISCLOSURE

The present disclosure relates to presenting advertising data and other information related to a television signal.

### BACKGROUND

Targeted advertising selects an advertisement and sends the advertisement to selected individuals who are targeted to receive the advertisement. Advertisers can potentially save advertising dollars by selecting who will receive their advertisements rather than indiscriminately broadcasting their advertisements to a general population of recipients. Thus, only those individuals selected by an advertiser receive the targeted advertisement in hope that the targeted recipients will be more responsive on a per capita basis than a general broadcast population. Advertisement distributors and providers that enable such an advertising model (e.g. Internet portals, television providers, access network providers) can correspondingly increase their revenue per advertisement impression by providing targeted advertising options for advertisers.

Targeted advertisements have historically been sent to targeted recipients so that advertisers reach only those advertising recipients who are deemed by the advertiser as most likely to be responsive to their advertisements.

### BRIEF DESCRIPTION OF THE DRAWINGS

FIG. 1 depicts an illustrative embodiment of a system for presenting data related to a television signal;

FIG. 2 depicts a flow chart of functions performed in a method for presenting data related to a television signal;

FIG. 3 depicts a data structure embedded in a computer readable medium that is used by a processor and method for presenting data related to a video data stream; and

FIG. 4 is an illustrative embodiment of a machine for performing functions disclosed in an illustrative embodiment.

### DETAILED DESCRIPTION

In a particular illustrative embodiment a computerized method for presenting advertising data related to a video data stream in an internet protocol television (IPTV) system is disclosed. The method includes sensing at an end user device, image reference data inserted at an IPTV advertising server into a video data stream from the IPTV system; weighting at the end user device, the image reference data sensed in the video data stream based on a data type for the sensed image reference data; and presenting advertising data concurrently with the video data stream at the end user device, wherein the advertising data is selected based on the weighted image reference data.

In another particular illustrative embodiment the image reference data further comprises data selected from the group consisting of image, video, audio and text and sensing further comprises an act selected from the group consisting of recognizing video reference data, recognizing image reference data, recognizing audio reference data and recognizing text reference data.

In another particular illustrative embodiment the data type is selected from the group consisting of video, audio, text and image.

In another particular illustrative embodiment the method further includes selecting regional reference data sensed in the video data stream based on weighted regional reference data received by the end user device from the IPTV server.

In another particular illustrative embodiment the image, video, audio and text reference data are substantially humanly imperceptible.

In another particular illustrative embodiment the weighting is based on a viewer tendency to respond to an advertising data type selected from the group consisting of image, audio, text and video data.

In another particular illustrative embodiment the advertising data further comprises data selected from the group consisting of image, audio, text and video data. The method further includes presenting at the end user device, the advertising data according an information data type selected from the group consisting of video, audio, text and image, wherein the advertising data for each advertising data type is presented in a separate area on the end user device.

In a particular illustrative embodiment a computerized method for inserting image reference data into a video data stream in an internet protocol television (IPTV) system is disclosed. The method includes sensing data in the video data stream at an IPTV server in the IPTV system and inserting the image reference data into the video data stream at the IPTV server based on the data sensed in the video data stream.

In another particular illustrative embodiment the image reference data further includes data selected from the group consisting of image, audio, video and text data further including sending regional reference data selected from the group consisting of video, audio, text and image data to an end user device for weighting at the end user device, the reference data sensed in the video data stream at the end user device.

In another particular illustrative embodiment sensing further includes an act selected from the group consisting of recognizing video data, recognizing image data, recognizing audio data and recognizing text data.

In a particular illustrative embodiment a computer readable medium containing a computer program for performing a computerized method for presenting advertising data in an internet protocol television (IPTV) system is disclosed. The computer program includes instructions to sense at an end user device, image reference data inserted at an IPTV advertising server into a video data stream from the IPTV system, instructions to weight at the end user device, the image reference data sensed in the video data stream based on a data type for the sensed reference data; and instructions to present the advertising data concurrently with the video data stream at the end user device, wherein the advertising data selected based on the weighted reference data.

In another particular illustrative embodiment in the computer program instructions, the image reference data further includes data selected from the group consisting of image, video, audio and text; and the instructions to sense further includes instructions to perform an act selected from the group consisting of recognizing video reference data, recognizing image reference data, recognizing audio reference data and recognizing text reference data.

In a particular illustrative embodiment a computer readable medium containing a computer program for performing a computerized method for inserting image reference data into a video data stream in an internet protocol television (IPTV) system is disclosed. The computer program includes instructions to sense data in the video data stream at an IPTV server in the IPTV system and instructions to insert the image reference data into the video data stream at the IPTV server based on the data sensed in the video data stream. In another particular illustrative embodiment the computer program further includes instructions to send regional reference data to an end user device for weighting at the end user device, reference data sensed in the video data stream at the end user device.

In a particular illustrative embodiment a computer readable medium having a data structure stored thereon, for providing functional and structural interrelationship between data stored in the data structure and computer hardware and software useful for presenting advertising data related to a video data stream is disclosed. The data structure includes a first field for containing data indicative of reference data; a second field for containing data indicative of weights for reference data types, sensed as inserted in an input video data stream wherein the reference data types are selected from the group consisting of image, video, audio and text data. In another particular illustrative embodiment the data structure further includes a third field for containing data indicative of a viewer response tendency to advertising using the reference data types. In another particular illustrative embodiment the data structure further includes a fourth field for containing data indicative of a reference data marker for the reference data.

In a particular illustrative embodiment a system for performing a computerized method for concurrently presenting a video data stream and related information data in an internet protocol television (IPTV) system is disclosed, wherein the related information is related to the video data stream. The system includes a processor in data communication with a computer readable medium; and a computer program embedded in the computer readable medium. The computer program includes instructions to sense at an end user device, image reference data inserted into a video data stream from the IPTV system, instructions to weight at the end user device, the image reference data sensed in the video data stream based on a data type for the sensed reference data and instructions to present at the end user device the related information data selected based on the weighted reference data concurrently with the video data stream.

In another particular illustrative embodiment in the computer program instructions, the image reference data further includes data selected from the group consisting of image, video, audio and text; and the instructions to sense further includes instructions to recognize video reference data, recognize image reference data, recognize audio reference data and recognize text reference data.

In a particular illustrative embodiment a system for performing a computerized a method for inserting image reference data in a video data stream in an internet protocol television (IPTV) system is disclosed. The system includes a processor in data communication with a computer readable medium; and a computer program embedded in the computer readable medium. The computer program includes instructions to sense data in the video data stream at an IPTV server in the IPTV system and instructions to insert the image reference data into the video data stream at the IPTV server based on the data sensed in the video data stream.

In another particular illustrative embodiment the image reference data further includes data selected from the group consisting of audio, video and text data and the computer program further includes instructions to send regional reference data to an end user device for weighting at the end user device, reference data sensed in the video data stream at the end user device.

In the past trying to incorporate a pure web browsing experience into the TV viewing experience is not always feasible nor what all users want. Instead, many see watching TV as the main experience, but want the ability to see related information and advertising data that compliments the experience without searching the internet to find the related information or using a keyboard or going away from the show they are viewing. The present disclosure illustrates a system and method for presenting related information and advertising directly related to the show (television signal or video data stream) being watched without requiring the user to web browse, use a keyboard or stop watching the show being watching. Related information such as statistics or a short biography video on a baseball player while watching a game, performance and pricing information on a car while viewing a car commercial, the recipe and a description of the cooking techniques while watching a cooking television show. These are only a short list of the types of television signal related information television viewers could have access to in a media rich format while watching TV in an illustrative embodiment. Advertising related to the video data stream is also presented. Thus, when image, video, text or audio data appears in a television signal, related to a particular advertiser's target market (demographic, sports interest, etc.) reference data is inserted into the television signal to be sensed by a processor at an end user device for presenting advertising data concurrently with the television signal.

In a particular illustrative embodiment users may be interested in receiving more information and advertising on different aspects of a TV show without having to stop watching it. However, there are issues with using a standard computer interface on the resolution available on a TV. Users may watch TV while having their laptop open on the side so they can watch the show and glance over at their laptop for related information. This still requires the user to look at two different sources and also requires them to go through a lot of work to search for the information on their laptop. The illustrative embodiment allows a user to continue watching the show while the system automatically brings up related advertising and information data such as topics that the user may browse on the side of the screen with just the push of a remote control button. The information is always related to what they are watching and will only take up a side portion of the screen, allowing the user to continue watching the show. When the user selects an advertisement data or related information data, the data type of the selected data is recorded to track a tendency of the user to respond to a particular data type for the advertising or related information.

Another particular illustrative embodiment allows a user to continue watching a show and when related information or advertising data is available for the show an audio icon, image, video or text message appears on the screen. The icon image or message indicates that an audio, video, image or text advertising or related information data is available for presentation upon selection of the icon via the remote control. The user may then select the image, message or icon by pressing a button on the remote control (which can be an existing button or a new one on the remote control) and the system disclosed in another particular illustrative embodiment automatically brings up related topics and advertising that the user may browse on the side of the screen with just the push of a button. The information is always related to what they are watching and will only take up a side portion of the screen, allowing them to continue watching the show.

Another particular illustrative embodiment substantially eliminates the need for a keyboard or requiring the user to think of keywords to type in as well as having to initiate a search on the internet. An illustrative embodiment presents the related information and advertising on the same screen with a television signal (IPTV video data stream) and still allows the user to continue watching their show (the television signal). In addition, a particular illustrative embodiment can be used to add related information and advertising with videos on demand or other media that would be ideal for viewing on a video display such as a television (TV) should the user choose to view. In another illustrative embodiment the related information is selected based on reference data inserted into the television signal and detected at the end user device.

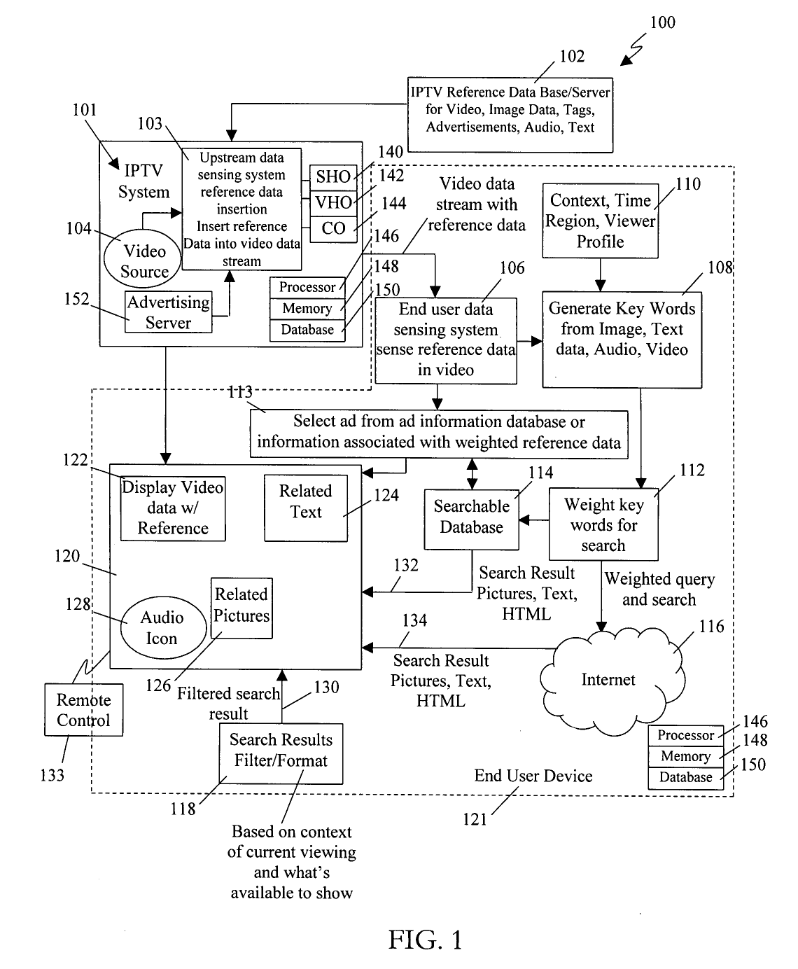

Turning now to FIG. 1, FIG. 1 shows an illustrative embodiment of a television signal delivery system, an internet protocol television (IPTV) system 101. The IPTV servers form a digital IPTV network that streams internet protocol (IP) video data and reference data from a super head end (SHO) server 140, video head end (VHO) server 142, or central office (CO) server 144 to a data sensing system 106 at an end user device. Thus, the IPTV system comprises a hierarchical network of servers (SHO, VHO, CO) that hierarchically distribute video data streams and reference data to smaller geographic regions and finally an end user device 121 such as a set top box device (STB). The SHO server delivers national video data (including image, video, text and audio data) content in the form of a television signal (digital video data stream) to regional VHO server, which redistributes the video data stream to sub regional CO servers. Each SHO, VHO, CO and end user device 121 contains an advertising/video data server having a processor 146, computer readable medium collectively referred to as memory 148 and database 150. The upstream data sensing system (UDSS) 103 and end user data sensing system (EUDSS) 106 sense data of different types that appear in the video data stream television signal. The EUDSS and UDSS compare television signal data to reference data to sense data in the television signal that matches or is substantially similar to the reference data. Reference data inserted by the UDSS 103 is sensed at the EUDSS by comparing the inserted reference data to a reference data queue of reference data sent to each end user device. Thus different end users receive different queues and sense different reference data at their respective EUDSS's. Each queue can contain different demographic reference data or regional reference data such as images, text or audio data so that each end user senses different geographic or regional reference data in the video data stream based on the queue of reference data and weighting data sent to their end user device. The queues, reference data and weighting data are stored in a data structure or database embedded in a computer readable medium accessible to a processor at the IPTV server or end user device.

The data sensed in the television signal may be of different data types, including but not limited to video data, image data, text data and audio data. The EUDSS.106 senses or recognizes video data, image data, text data and audio data in the television signal to generate keywords from the combination of the images, audio and text data sensed in the incoming video signal. In a particular illustrative embodiment, the incoming television signal is a digital data stream, delivered from an IPTV system network of servers. In another particular illustrative embodiment, the television signal is a digital television signal delivered over a broadcast cable system. In another particular illustrative embodiment, the television signal is an analog television signal delivered over a radio frequency antenna. In another particular illustrative embodiment, reference video data, reference image data, reference text data, reference audio data and weighting (herein after referred to as “reference data”) are inserted into the video data stream television signal by the EUDSS in the IPTV system.

The weighting data can be inserted into the television signal or sent separately to an end user device. The weighting data is used to weight data types, regional reference data and viewer or demographic tendency to respond to a data type. The reference data can be sensed by a EUDSS 106 at an end user device 121 such as a set top box. In another particular embodiment, the end user device is a mobile IP device including but not limited to a cell phone, personal data assistant or a web tablet. The reference data is compared to video, audio, image and text data in the incoming television signal to select related information data and advertising data for presentation concurrently or offered via an icon to be selected for presentation concurrently along with the incoming television signal on the end user device. As an end user responds to a particular data type by selecting a particular advertising data or related information data for viewing, the end user response to the data type is recorded to determine the end user's response tendency for the data type.

The reference data weighting data is used to weight reference data according to the data type, geographic region and according to a tendency to respond to a particular data type of an end user or an end user's demographic. Each end user's response to a particular data type is recorded and stored at the end user device. A tendency for each user to respond to a data type is determined from the recorded responses and used to determine a tendency of an end user to respond to the data type. Weights are assigned to data types based on the user's response tendency for data types. These tendencies are reported to the IPTV system servers for the end user and end user demographic group. Thus, weighting data for each end user and end user demographic group can be stored at the IPTV server and used to distribute weighting data to demographic groups of end users and individual end users.

In a particular illustrative embodiment the weighting data that may be included is a set of weights assigning data type weights, response tendency weights, viewer profile weights, or regional weights. In another particular embodiment the weighting data includes weighted reference data, which is used to favor selection of the weighted data type from reference data sensed by the EUDSS. Thus the weight reference data will be favored or weighted more heavily than other reference data sensed by the EUDSS. For example if a particular end user or a demographic for a particular end user has a tendency to respond more to text data than audio data, then sensed reference text data will be weighted more heavily than sensed audio data. Similarly, if an end user is in a particular demographic group with a known response to particular data types or a particular end user has a tendency to respond more to video or image data than text data, then sensed reference video or image data will be weighted more heavily than sensed text data for the particular end user or demographic group of end users. The weighted sensed data is used to select related information to display concurrently with the television signal or made selectively available to be displayed concurrently along with the television signal. Thus, for an end user more responsive to text data, text related information is weighted more than video, audio and image data so that text data is displayed to the particular end user.

Reference data can be supplied to the data sensing device 106 by a general reference data database 103 or by an advertiser reference data database 102. The advertiser reference data database 102 can contain video data, image data, audio data, text data, data tags and advertisements which can be used for selection and presentation of related information and advertising data for human perception and selection as presented on an end user device with video provided by the IPTV system. The advertiser or other user can sense data in the upstream data sensing system 103 to select reference data associated with sensed video data in the television signal to insert into the video data stream. The advertiser or user can select regions, data types and demographics by selecting weighting data or weighted reference data for insertion into the television signal or downloading to an end user device from the IPTV network SHO, VHO or CO. Each reference data can have a particular weight assigned to it in the database and can be used to weight sensing of the reference data. Keywords associated with reference data can be weighted by the particular weights for weight searches. Search results can be weighted by using the weights. The weighting data for the reference data can be included in a separate download to the end user device and stored in memory in a data structure or database embedded in a computer readable medium.

In an illustrative embodiment the data sensing device recognizes images, text and audio passages to select related information and to generate keywords for searching for related information. The matched reference data or keywords are sent to system 108 where the matched reference data or keywords are weighted according to their weights and their significance of the media or data type of which they were recognized including audio, video, image and text or optical character recognition (OCR) in system 108. The audio and text passages included keywords that are identified using speech recognition and text recognition techniques. A default weighting data for data type weight is assigned on a scale of 10, for audio data=7, video/image data=5, and text data=3. Those weights can be adjusted by weighting the reference data downloaded to the end user device. Additional weight is assigned to keywords (e.g., football, Corvette, Wild at Heart) in the same category (e.g., sports, politics, cars, movies, etc.) appearing in more than one data type at substantially the same time (e.g., within 2 seconds). Thus if the image of a football and the word “football” which are in the same category, i.e., sports, are sensed in the television signal at the same or close to the same time, additional weight is assigned to the keyword football.

The keywords can also be weighted by the context, which includes time of day, geographic region and current viewer profile, response tendency, demographic, which is provided by system 110. Thus the keyword “Dallas Cowboys” can be assigned more weight in Texas than Washington, D.C. The keywords, which are weighted according to the inputs in block 108, are sent to system 112 where the keywords are generated for a search. A keyword search is performed either on the internet or some other data communication system 116 or in a database 114. The search results of the internet search may include images or pictures, text and HTML data including URLs to particular web sites. In an illustrative embodiment, the search results from the internet 134 are provided to a search results filter 118 where the results are weighted and reduced for presentation on an end user presentation device, such as an IPTV video display 120. The results of the database search in database 114 can include image, audio, video, pictures, text and HTML data 132 which are sent to the search results filter for (weighting using the weighting data) and formatting for display on IPTV video display 120.

Weighted search results or related advertising and information data 130 are sent to the video display 120 and are displayed concurrently along side the television signal, which is displayed in area 122 of the video display 120 of the end user device 121. Image search results can be displayed as related image information in a separate area for related image information 126 and additional search results for scrolling and further investigation can be placed in area 124 on the video display. An icon 128 can be presented on the video display for indication that additional search results containing related information are available so that when a user clicks on the icon using a remote control 133 to communicate with the processor 148 and presentation device 120 can present the additional related information data along with the video display. Upon activation of the additional results icon the video display is reduced from full screen for the video display 122 to a reduced screen which can be left justified in the upper left hand corner of the video display and making room for additional related information to be displayed in their particular area according to their media format, audio, video or text. Audio data results can be associated with an audio icon 128 so that audio data can be provided as additional related information upon selection of the audio icon.

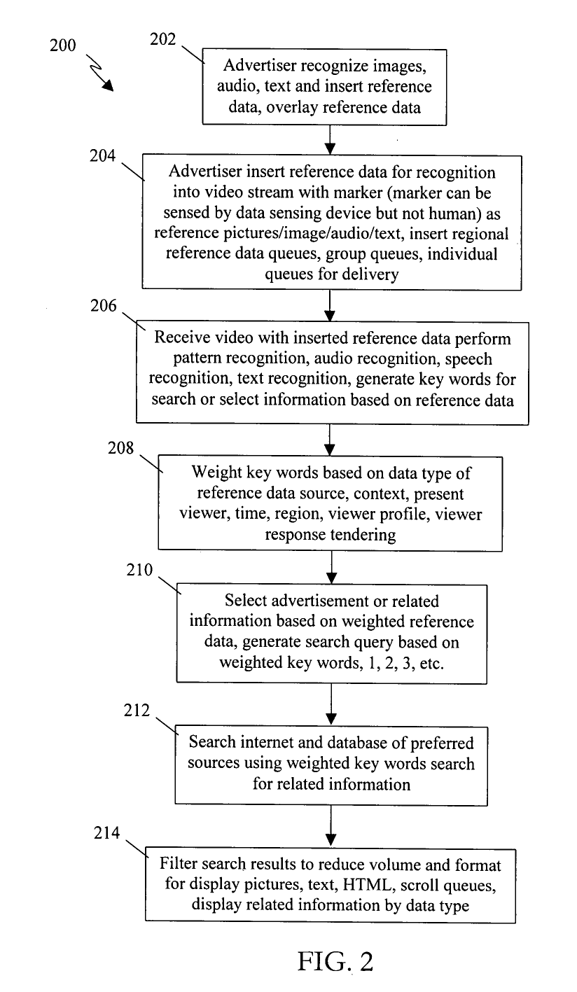

Turning now to FIG. 2 in an illustrative embodiment a series of functions are performed to provide reference data sensing, recognition and categorization for selection of related information and advertising presentation data and generation of keywords to provide additional related information data and advertising data related to the incoming television signal, which in an illustrative embodiment is an IP video data stream delivered from an IPTV server 104. A flow chart 200 illustrates a series of steps in an illustrative embodiment, which are used to perform the functions described herein.

In block 202 an advertiser or other user recognizes video, images, and audio and text data in a video data stream. The advertiser or other user uses the IPTV system to insert reference data and weighting data into the video data stream for distribution to end user device. An advertiser database is used for data sensing, recognizing and characterization of the video data stream by a particular illustrative embodiment. The reference data and weighting data are sent to an end user device where the reference data and weighting data are used to compare to reference data in the video stream to sense or recognize particular data elements with which an advertiser, user or other interested party may be associated. Thus, when a particular reference data appears in a video stream that related information data or advertising data associated with the reference data can be retrieved from a data base presented concurrently along with the video data stream. The reference data and advertising data is stored in a data base with relational data associating the reference data with particular related information or advertising data.

For example, an advertiser may put reference image data of a particular make of vehicle into reference data and have the IPTV system send the reference data to the end user device. When the data sensing system senses a particular occurrence of an image, video, text or audio data in the data stream that is substantially similar o the reference data image, video, text or audio data a search is performed in a database to find related information or advertisement associated with the occurrence of that reference in the video data stream. The reference image, video, text or audio data can also have particular advertisement image, video, text or audio data or related information image, video, text or audio data directly associated with the reference for concurrent presentation with the video data stream at an end user device.

In addition, the reference data inserted into the television signal, in an illustrative embodiment, a video data stream, may have reference data inserted into the video, which are substantially imperceptible or not perceptible to a human viewer/listener but are sensed by the EUDSS 106. For example, a video signal containing reference data (audio, video, text, and image data) may appear to a human viewer/listener as regular video. In another particular embodiment the reference data is enhanced with an image, video, text or audio data marker so that the marker may not be visually or audibly perceptible or recognizable by a human but can be recognized by the UDSS 103 or EUDSS 106. The marker is inserted by the IPTV system at an IPTV server (SHO, VHO, CO).

The marker or reference data can be a temporary duration or flash of pixel intensity that is barely perceptible or substantially imperceptible by the human eye but the marker or reference data is perceptible by the EUDSS 106 as high intensity for a brief period of time. The marker can be a particular pixel pattern or other data, which indicates that the image is an element to be used in a display of additional reference information associated with the video data stream. Audio reference data may be inserted into the television signal at a frequency or duration, which can be sensed by the data sensing device but is substantially imperceptible to a human viewer/listener to whom the television signal is presented at an end user device.

Text data may be inserted into the television signal for a duration, which can be sensed by the EUDSS 106 but is substantially imperceptible to a human viewer/listener to whom the television signal is presented at an end user device. In another particular embodiment data sensed in the television at the UDSS 103 is replaced or overlaid with reference data, at the UDSS. Thus the reference data can be overlaid or inserted into the television signal to replace the sensed data in the television signal. The overlay data for a particular advertiser's car can be replaced with an overlay reference data for the advertiser's car sensed by the UDSS 103 to be sensed at the EUDSS. The overlay may be present temporarily as an imperceptible flash in the television signal but will be sensed by the EUDSS 103 if the advertising reference data matching the car has been downloaded to the end user device.

In block 204 a data sensing system (EUDSS or UDSS) receives the video data and performs pattern recognition on the video, image, audio and text data occurring in the video data. The data sensing system selects related information or advertising data associated with the reference data from a data base or generates keywords which are passed to block 206 where the keywords are weighted based on the context which includes the present viewer, the time, geographic region and current viewer profile. Certain keywords are also weighted more highly than others depending on the context, such as viewer profile of interests in a particular category, i.e., sports, history, time of day, demographic of viewer, geographic region, etc.

In another particular embodiment, the keywords are also weighted based on the data type from which the keywords were generated based on a response tendency weighting for users in general or particular users or demographics. In another particular embodiment the weighting data is used to weight the keywords. In block 208 a search generated based on the top weighted keywords, for example, the top weighted keywords may comprise either the first, second or first, second, and third top ranked keywords out of 100 or more keywords associated with a sensed reference data. Related information data can also be directly associated with the matching of sensed reference data to a database of related information, including but not limited to advertisements and supplemental data or related information (information related to the television signal).

In block 210 an internet search is performed based on the top keywords and a database of preferred sources can be performed using the top keywords. The search will search for images, text and audio including HTML data, which are associated with the occurrence or a given combination of image, text, and audio reference data. The reference data and associated key words can be used to search for and access a particular advertiser web site on the internet for downloading of related advertising data from the advertiser's web site. In block 212 the search results are filtered to reduce the volume of search results. The search results are also formatted for display in the particular areas of the video display. Pictures, text, HTML and audio data can be presented in separate areas of the video display. Icons can be used for representation of available audio data. Each of the images, audio, video or text and icons can be available presented as scrollable queues of data so that a user can advance and backup within a particular queue of scrollable image, text, HTML or audio icon items.

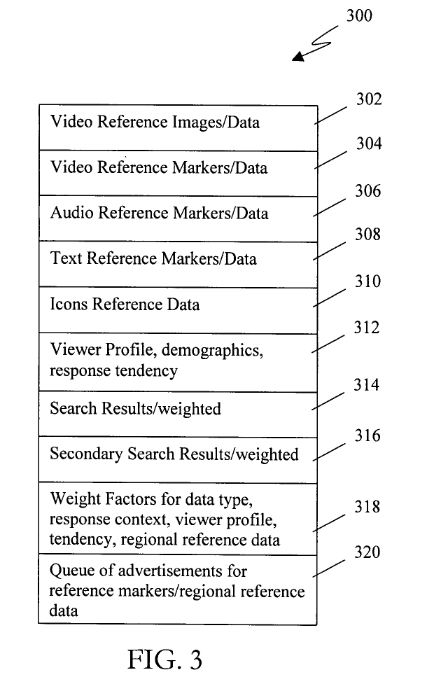

Turning now to FIG. 3 in a particular illustrative embodiment a data structure 300 embedded in a computer readable medium for providing a structural and functional interrelationship between the data in the data structure and a processor, processor software or method for presenting data related to a video data stream. In block 302 a video reference image field is illustrated in which data is contained indicating a particular video reference image, or a plurality of particular video reference images for use by an UDSS or EUDSS in sensing video reference images. Video reference data weighting data are also contained in block 304 a video marker field is illustrated in which data is contained indicating a particular video data marker for use by an UDSS or EUDSS in sensing a video marker in a video data. In block 306 an audio reference data, weighting and marker field is illustrated in which data is contained indicating a particular audio reference data, weighting and marker for use in a UDSS or EUDSS for sensing and weighting an audio reference and audio marker data in the television signal. In block 308 a reference data, weighting and text marker field is illustrated in which data is contained indicating a particular text reference data and marker data for use in sensing and weighting text data. In block 310 an icon field is illustrated in which data is contained indicating a particular icon for use in presenting an icon for each data type of related data available for presentation on an end user display. In block 312 a viewer profile field is illustrated in which data is contained indicating a particular viewer profile. The viewer profile can include but is not limited to demographic data, viewer data type response tendency data, weighting data, viewer history data, interest data, geographic location data, etc. In block 314 a search results/weighted field is illustrated in which data is contained indicating a particular weighted search result. In block 316 a secondary search results/weighted field is illustrated in which data is contained indicating a particular secondary weighted search result resulting from a search of the search results in field 314. In block 318 a weight factors field is illustrated in which data is contained indicating a particular weight factor for each data type (audio, video, text, and image) based on a response tendency of the end user or an end user demographic. In block 320 a queue field is illustrated for containing data indicative of a queue of advertising data for the reference data. The advertising data can be stored and accessed in a data base or data structure embedded in a computer readable medium located at an IPTV advertising server or located at an end user device. The advertising data can be accessed using advertising identifier data in the queue.

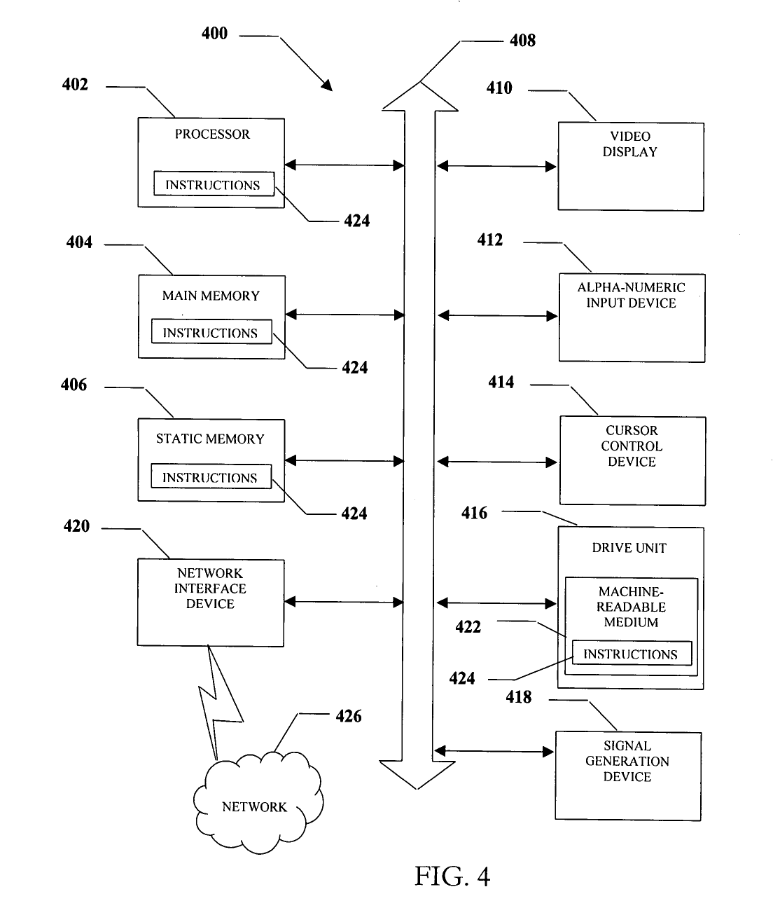

FIG. 4 is a diagrammatic representation of a machine in the form of a computer system 400 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU), or both), a main memory 404 and a static memory 406, which communicate with each other via a bus 408. The computer system 400 may further include a video display unit 410 (e.g., liquid crystals display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface 9.

The disk drive unit 416 may include a machine-readable medium 422 on which is stored one or more sets of instructions (e.g., software 424) embodying any one or more of the methodologies or functions described herein, including those methods illustrated in herein above. The instructions 424 may also reside, completely or at least partially, within the main memory 404, the static memory 406, and/or within the processor 402 during execution thereof by the computer system 400. The main memory 404 and the processor 402 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420. The machine readable medium may also contain a data structure for containing data useful in providing a functional relationship between the data and a machine or computer in an illustrative embodiment of the disclosed system and method.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computerized method for presenting advertising data related to a video data stream in an internet protocol television (IPTV) system, the method comprising:
sensing at an end user device, image reference data inserted at an IPTV server into a video data stream from the IPTV system;
weighting at the end user device, the image reference data sensed in the video data stream based on a data type for the sensed image reference data; and
presenting the advertising data concurrently with the video data stream at the end user device advertising data related to the video data stream, wherein the advertising data is selected based on the weighted image reference data.

2. The method of claim 1, wherein the image reference data further comprises data selected from the group consisting of image, video, audio and text and sensing further comprises an act selected from the group consisting of recognizing video reference data, recognizing image reference data, recognizing audio reference data and recognizing text reference data.

3. The method of claim 1, wherein the data type is selected from the group consisting of video, audio, text and image.

4. The method of claim 1, the method further comprising:
selecting regional reference data sensed in the video data stream based on weighted regional reference data received by the end user device from the IPTV server.

5. The method of claim 2, wherein the image, video, audio and text reference data are substantially humanly imperceptible.

6. The method of claim 3, wherein the weighting is based on a viewer tendency to respond to a data type.

7. The method of claim 3, wherein the advertising data further comprises data selected from the group consisting of image, audio, text and video data, the method further comprising:
presenting at the end user device, the related advertising data according an information data type selected from the group consisting of video, audio, text and image, wherein the information data for each related advertising data type is presented in a separate area on the end user device.

8. A computerized method for inserting image reference data into a video data stream in an internet protocol television (IPTV) system, the method comprising:
sensing data in the video data stream at an IPTV server in the IPTV system; and
inserting the image reference data into the video data stream at the IPTV server based on the data sensed in the video data stream.

9. The method of claim 8, wherein the image reference data further comprises data selected from the group consisting of image, audio, video and text data further comprising:
sending regional reference data selected from the group consisting of video, audio, text and image data to an end user device for weighting at the end user device, the reference data sensed in the video data stream at the end user device.

10. The method of claim 8, wherein sensing further comprises an act selected from the group consisting of recognizing video data, recognizing image data, recognizing audio data and recognizing text data.

11. A computer readable medium containing a computer program for performing a computerized method for presenting advertising data in an internet protocol television (IPTV) system, the computer program comprising instructions to sense at an end user device, image reference data inserted at an IPTV advertising server into a video data stream from the IPTV system, instructions to weight at the end user device, the image reference data sensed in the video data stream based on a data type for the sensed reference data; and
instructions to present concurrently with the video data stream at the end user device, advertising data selected based on the weighted reference data.

12. The medium of claim 11, wherein in the computer program instructions, the image reference data further comprises data selected from the group consisting of image, video, audio and text and the instructions to sense further comprise instructions to perform an act selected from the group consisting of recognizing video reference data, recognizing image reference data, recognizing audio reference data and recognizing text reference data.

13. A computer readable medium containing a computer program for performing a computerized method for inserting image reference data into a video data stream in an internet protocol television (IPTV) system, the computer program comprising instructions to sense data in the video data stream at an IPTV server in the IPTV system and instructions to insert the image reference data into the video data stream at the IPTV server based on the data sensed in the video data stream.

14. The medium of claim 13, the computer program further comprising:
instructions to send regional reference data to an end user device for weighting at the end user device, reference data sensed in the video data stream at the end user device.

15. A computer readable medium having a data structure stored thereon, for providing functional interaction between data stored in the data structure and a computer useful for presenting data related to a video data stream, the data structure comprising:
a first field for containing data indicative of reference data;
a second field for containing data indicative of weights for reference data types, sensed as inserted in an input video data stream wherein the reference data types are selected from the group consisting of image, video, audio and text data.

16. The medium of claim 15, the data structure further comprising:
a third field for containing data indicative of a viewer response tendency to the data types.

17. The medium of claim 15, the data structure further comprising:
a fourth field for containing data indicative of a reference data marker for the reference data.

18. A system for performing a computerized method for presenting related information data in an internet protocol television (IPTV) system, the system comprising:
a processor in data communication with a computer readable medium; and
a computer program embedded in the computer readable medium, the computer program comprising instructions to sense at an end user device, image reference data inserted into a video data stream from the IPTV system, instructions to weight at the end user device, the image reference data sensed in the video data stream based on a data type for the sensed reference data and instructions to present at the end user device the related information data selected based on the weighted reference data concurrently with the video data stream.

19. The system of claim 18, wherein in the computer program instructions, the image reference data further comprises data selected from the group consisting of image, video, audio and text and the instructions to sense further comprise instructions to recognize video reference data, recognize image reference data, recognize audio reference data and recognize text reference data.

20. A system for performing a computerized a method for inserting image reference data in a video data stream in an internet protocol television (IPTV) system, the system comprising:
a processor in data communication with a computer readable medium; and
a computer program embedded in the computer readable medium, the computer program comprising instructions to sense data in the video data stream at an IPTV server in the IPTV system and instructions to insert the image reference data into the video data stream at the IPTV server based on the data sensed in the video data stream.

21. The system of claim 20, wherein the image reference data further comprises data selected from the group consisting of audio, video and text data and the computer program further comprising:
instructions to send regional reference data to an end user device for weighting at the end user device, reference data sensed in the video data stream at the end user device.
